(19) United States
(12) Patent Application Publication
(10) Pub. No.: US 2007/0252118 A1
(43) Pub. Date: Nov. 1, 2007

(54) Power jack and accessory light

(76) Inventor: Moses Green JR., Bridgeport, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/728,235

(22) Filed: Mar. 23, 2007

Related U.S. Application Data
(60) Provisional application No. 60/785,674, filed on Mar. 23, 2006.

(51) Int. Cl. B66F 3/44

(52) U.S. Cl. 254/13; 315/291

(57) ABSTRACT

A powerjack includes a base, a lift member, a lift mechanism supporting the lift member on the base, and an electric motor operably connected to lift mechanism, for operating the jack. The jack may be combined with a power cord having two ends, with one end operably connectable to the motor and having a power source attachment on the other end. Optionally, there may be at least one accessory light operably connected to the power cord. A light accessory that may be used apart from the jack includes a power cord, an inlet plug, a source plug, and an accessory light connected to the power cord.

### CROSS-REFERENCE TO RELATED APPLICATION

This application claims the benefit of U.S. provisional application number 60/785,674, filed Mar. 23, 2006, which is hereby incorporated herein by reference, in its entirety.

### FIELD OF THE INVENTION

This invention relates to car jacks, and in particular to motorized car jacks.

### BACKGROUND

A typical jack has a base and a lift member, and a lifting mechanism between the base and the lift member. The lifting mechanism gives the user a mechanical advantage for lifting a load. Jacks are used in various ways, for example, to lift an automobile so that a driver can deal with a flat tire by removing the flat tire from the vehicle and replacing it with a spare. Even with the mechanical advantage that a jack offers, many people find the task of changing a tire, or other tasks for which the jack is used, to be difficult. Furthermore, it is often necessary to perform such tasks in dangerous places. For example, it may be necessary to change a tire on the shoulder of a road or highway, with other vehicles passing nearby, thus exposing the person changing the tire to the risk of being hit by a vehicle whose driver did not see the person changing the tire. In addition, it is often necessary to change a tire outdoors at night, where there is inadequate lighting.

Based on the foregoing, it is the general object of this invention to provide a jack that improves upon, or overcomes the problems and drawbacks of prior art jacks.

### SUMMARY OF THE INVENTION

The present invention resides in one aspect in a power jack that includes a base, a lift member, a lift mechanism supporting the lift member on the base, and an electric motor operably connected to lift mechanism, for operating the jack.

In specific optional embodiments, the jack may be combined with a power cord having two ends, with one end operably connectable to the motor and having a power source attachment on the other end. In another optional embodiment, there may be at least one accessory light operably connected to the power cord.

The present invention resides in another aspect in a light accessory that includes a power cord, an inlet plug, a source plug, and an accessory light connected to the power cord.

### BRIEF DESCRIPTION OF THE DRAWING

FIG. 1 is schematic elevation view of one embodiment of a jack according to the present invention; and

FIG. 2 is a schematic elevation view of a one embodiment of a power cord for use with the jack of FIG. 1.

### DETAILED DESCRIPTION OF THE INVENTION

The present invention provides a jack with a motorized lift mechanism. In a specific embodiment, the motor can be powered from the electric battery of a motor vehicle. In a preferred embodiment, the motor is powered via a power cord having a cigarette lighter attachment that permits power to be drawn from the vehicle battery via the cigarette lighter fixture in the passenger compartment. This invention also provides an accessory light that may be used with the jack or separately from the jack. The accessory light may be connected to the power cord for the motor. The accessory light may include a hazard light that the user can position to be seen by oncoming traffic, thus increasing the user's visibility to other drivers to reduce the risk of being hit by oncoming traffic while changing the tire. The accessory light may also include a spot light that the user may use to alleviate poor ambient lighting conditions, for example, should the user be changing the tire at night on an unlit road. The jack motor and accessory light may be responsive to a remote control unit, for ease of use.

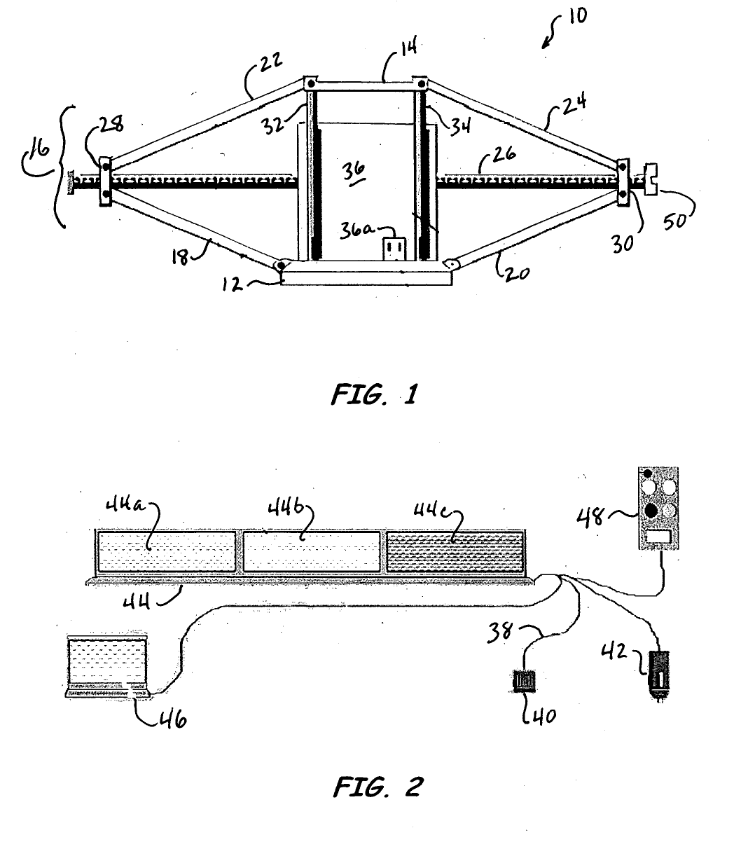

One embodiment of a jack as described herein is shown in FIG. 1. Jack 10 comprises a base 12, a lift member 14, and a lift mechanism 16 that connects the lift member 14 to the base 12 and that can be operated to raise or lower the lift member 14 relative to the base 12. The lift mechanism 16 is a screw-type lift mechanism that comprises four articulated support arms 18, 20, 22, 24, a jack screw 26 and pivot nuts 28 and 30. The support arms include two base arms 18, 20, that have base ends that are pivotably mounted on the base 12. Base arms 18, 20 also have screw ends that are pivotably connected to first and second pivot nuts 28, 30 through which a screw passes. Thus, arms 18 and 20 are pivotably connected to screw 26.

The support arms also include lift arms 22, 24, which have screw ends that are pivotably connected to the pivot nuts 28 and 30. Thus, arms 22 and 24 are pivotably connected to screw 26 and to arms 18 and 20, at their respective screw ends. The lift arms 22, 24 also have lift ends that are pivotably connected to the lift member 14.

Jack 10 includes at least one, optionally two upright posts 32 and 34 mounted on base 12. Optionally, lift member 14 slidably engages upright posts 32 and 34 at least when lift member 14 is in the lowered position.

The positions of the pivot nuts 28 and 30 (and of the screw ends of the support arms) relative to the screw 26 and to each other can be controlled by rotating the screw 26 relative to the pivot nuts. Rotated in one direction, screw 26 brings the pivot nuts 28 and 30 (and therefore, the screw ends of the support arms 18, 20, 22, 24) together, making the support arms increasingly vertical and raising the lift member 14 relative to the base 12. Rotating the screw 26 in the other direction has the opposite effect.

In accordance with this particular embodiment of the invention, an electric motor 36 is mounted on the base 12 via vertical sliding engagement with posts 32 and 34. Motor 36 operably engages the screw 26 so that the motor 36, when energized, can rotate the screw 26 and thus raise or lower the lift member 14 (and a vehicle thereon) relative to the base 12. Motor 36 rises and falls with screw 26 by sliding along posts 32 and 34.

Motor 36 has a power inlet 36a to which a power cord such as cord 38 (FIG. 2) may be attached to provide electrical power to the motor 36. On end of cord 38 is equipped with an input plug 40 that is adapted to fit into inlet 36a. Another end of cord 38 is equipped with a source plug 42. In a preferred embodiment, source plug 42 is an adapter for a vehicular cigarette lighter. Thus, the motor 36 can conveniently draw power from the vehicle battery via the cigarette lighter fixture in the passenger compartment of the vehicle.

An optionally first accessory light 44 is connected to the power cord 38. The first accessory light 44 is a hazard flasher light that can be placed where it can be seen by oncoming traffic. The hazard flasher light 44 includes several light panels 44a, 44b and 44c that may differ in color from each other and/or that may flash in sequence. The hazard flasher light provides increased visibility and serves to draw the attention of other drivers passing by.

A second accessory light 46 is also connected to the power cord 38. The second light 40 is a spot light to alleviate poor ambient lighting conditions, for example, should the user be changing the tire at night on an unlit road.

Either or both of accessory light 44 or 46 may include a magnetic base to allow the light to be mounted on a metal body part of the vehicle.

Optionally, one or more of the motor 36 and accessory lights 44 and 46 are responsive to a remote control 48, which is optionally connected to power cord 38.

To use the jack 10 to change a tire, the jack 10 is placed on a firm, level surface beneath the appropriate part of the vehicle. The hazard flasher light 44, if provided, is placed in position for view by drivers of oncoming vehicles. The spotlight 46, if provided, is placed by the user where desired to improve the illumination of the work site. The power cord 38 is connected to the motor 36 and to a vehicle power source, e.g., the adapter 42 is plugged into the vehicle cigarette lighter fixture. Preferably, the user loosens the lug nuts on the wheel to be removed before the jack 10 raises the wheel off the ground. The user activates the motor 36 and, optionally, the one or more of the accessory lights 44, 46, optionally by using the remote controller 48. Once the damaged wheel is off the ground, the damaged wheel is removed and is replaced by a spare. The vehicle is then lowered. Preferably, the lug nuts on the spare wheel are tightened after the car is lowered off the jack. The power cord is disconnected from the power supply, the accessory lights are collected and the jack is removed from beneath the vehicle and is returned to a storage place on the vehicle.

The screw 26 includes an optional clevis 50 for use with a conventional, optional, hand crank that can be used should the motor 36 fail or should a power supply be unavailable (e.g., should the vehicle battery go dead).

In an alternative embodiment, the invention provides an accessory lighting system comprising one or more accessory lights 44, 46 that may be powered from the vehicle battery without also using jack 10.

It will be understood from the above description that this invention allows a user to lift a vehicle to permit the change of a tire with greater safety and with the use of less strength than prior art jacks.

The terms “first” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A powerjack comprising:
a base;
a lift member;
a lift mechanism supporting the lift member on the base; and
an electric motor operably connected to lift mechanism, for operating the jack.

2. The jack of claim 1, in combination with a power cord having two ends with one end operably connectable to the motor and having a power source attachment on the other end.

3. The jack of claim 2, further comprising at least one accessory light operably connected to the power cord.

4. The jack of claim 1, wherein the lift mechanism comprises:
a screw, two base arms pivotably mounted to the base and to the screw, and two lift arms pivotably mounted to the screw and to the lift member;
wherein the motor operably engages the screw.

5. The jack of claim 4, comprising an upright post mounted on the base, wherein the motor is slidably mounted on the post.

6. The jack of claim 1, wherein the motor comprises a power inlet, further in combination with a power cord comprising an input plug and a source plug.

7. The jack of claim 6, wherein the source plug is a vehicle cigarette lighter plug.

8. The jack of claim 6, further comprising an accessory light connected to the power cord.

9. The jack of claim 8, further comprising a remote control unit on the power cord, for controlling the motor and/or the accessory unit.

10. A light accessory, comprising:
a power cord;
an inlet plug;
a source plug; and
an accessory light connected to the power cord.

11. The light accessory of claim 10, further comprising a remote control connected to the power cord for controlling the accessory light.
